(19) United States
(12) Patent Application Publication
(10) Pub. No.: US 2012/0135410 A1
(43) Pub. Date: May 31, 2012

(54) METHOD FOR IMAGING ON THIN SOLID-STATE INTERFACE BETWEEN TWO FLUIDS

(76) Inventors: Gautam V. Soni, Bikaner (IN); Amit Meller, Brookline, MA (US)

(21) Appl. No.: 13/245,261

(22) Filed: Sep. 26, 2011

Related U.S. Application Data
(63) Continuation of application No. PCT/US2010/028845, filed on Mar. 26, 2010.
(60) Provisional application No. 61/211,260, filed on Mar. 26, 2009.

(51) Int. Cl. G01N 21/75; B01L 3/00; B82Y 15/00

(52) U.S. Cl. 435/6.12; 422/547; 436/501; 977/781; 977/902

(57) ABSTRACT

Described herein is a fluid cell for an optical microscopy tool having a solid state membrane having a first side and a second, opposing side; a first fluid chamber comprising a first fluid having a first refractive index located on the first side of the membrane; and, a second fluid chamber comprising a second fluid having a second refractive index located on the second side of the membrane, the second refractive index being different than the first refractive index. Also described herein is a method for imaging a single biomolecule, the method including generating a field of evanescent illumination at a solid state membrane between a first fluid and a second fluid having different refractive indexes; and detecting light emitted by optical detectors linked to the single biomolecules at the solid state membrane.

### CROSS-REFERENCE TO RELATED APPLICATIONS

This application is a continuation of International Application No. PCT/US2010/028845, filed Mar. 26, 2010, which claims the benefit of priority to U.S. Provisional Application No. 61/211,260, filed Mar. 26, 2009, the entire disclosures of which are hereby incorporated by reference.

### GOVERNMENT SUPPORT

This invention was made with Government Support under Contract No. HG-004128 awarded by the National Institutes of Health. The Government has certain rights in the invention.

### FIELD OF THE INVENTION

The present invention relates to the field of optical microscopy. In particular, the invention utilizes a thin solid-state interface between two fluids for improved imaging of biomolecules.

### BACKGROUND

The completion of the first reference human genome sequence has marked the commencement of an era in which genomic variations directly impact drug discovery and medical therapy. This new paradigm has created an imminent need for inexpensive and ultrafast methods for DNA sequencing. In the near future, medical practitioners will be able to routinely analyze the DNA of individual patients in a clinical setting before prescribing drugs, and check them against online databases in which genomic information relevant to any drug is documented. In addition, affordable sequencing technologies will transform research in comparative genomics and molecular biology, allowing scientists to quickly sequence whole genomes from cell variants. To realize ultrafast and inexpensive DNA sequencing, new technologies are needed to replace the classical methods based on Sanger's dideoxy protocol. These new technologies should address two main bottlenecks: (1) sample size should be reduced to a minimum, enabling sequence readout from a single DNA molecule or a small number of copies; and (2) readout speed should be increased by several orders of magnitude compared with current state-of-the-art techniques.

Solid-state surfaces like silicon nitride, silicon oxide and others have been used in a variety of biomedical applications including tissue engineering, implantable devices and basic research contexts. Thin solid state surfaces have been used in the context of different micro- and nano-structural devices, such as, for example, nanoslits and nanopore arrays used in biosensing and DNA sequencing applications. Silicon nitride membranes have been recently shown to be a suitable substrate for creating solid-state nanopores for applications such as biomolecular detection and DNA sequencing. Solid-state devices involving single molecule optical detection of DNA translocation and unzipping through a solid-state nanopore have been envisaged to be crucial for biosensing and genome sequencing. For single molecule in vitro measurement of optical signals through these devices it is useful to use the evanescent mode of microscopy.

In the fields of biomedical research and medical devices, the ability to study molecules, cells and tissues by imaging through materials of interest is desirable. One such imaging technique is total internal reflection fluorescence microscopy (TIRFM or TIRF). The solid state materials that have been used in those contexts, however, are incompatible with state-of-the-art optical microscopy methods, such as TIRF. In existing techniques, it is a difficult to bring these solid state material surfaces in the evanescent field of another surface, such as a glass coverslip, and it is extremely tedious to construct the nano-fluidic channels required to bring the silicon nitride membrane and the biological sample in the TIRF evanescent field regime. Furthermore, due to the inherent density of particles (even in the clean room environment), particulates generated during the processing of these silicon nitride chips, and limitations of temperature constraints of these silicon nitride membrane chips, sealing these nanopores with silicon nitride surfaces is a difficult task.

### SUMMARY OF THE INVENTION

Embodiments of the present invention achieve evanescent mode excitation at these solid-state membranes (carrying nanopore devices or other biological samples) by index-matched TIRFM (Total Internal Reflection Fluorescence Microscopy) between two media across these membranes. This allows for the acquisition of high resolution, high contrast and high sensitivity images of one or more biomolecules on the membrane.

According to one aspect of the invention, a fluid cell for an optical microscopy tool is disclosed that includes a solid state membrane having a first side and a second, opposing side; a first fluid chamber located on the first side of the membrane, the first fluid chamber comprising a first fluid having a first refractive index; and a second fluid chamber located on the second side of the membrane, the second fluid chamber comprising a second fluid having a second refractive index, the first refractive index being higher than the second refractive index.

The solid state membrane may be silicon nitride, silicon oxide, aluminum oxide, titanium oxide or other dielectric materials.

The solid state membrane may include a silicon nitride layer deposited on a silicon wafer. The silicon nitride layer may be 5-50 nm thick. The silicon wafer may include a window and the silicon nitride layer covers or extends across the window.

The first fluid may be an aqueous buffer solution or water. The second fluid may be cellular fluid, cell membrane or glycerol. The first fluid may be concentrated urea solution or CsCl solution.

A biomolecule linked to an optical biomarker may be provided on the second side of the membrane. The biomolecule may be a DNA molecule. The biomolecule may be a RNA molecule. The biomolecule may be a protein molecule. The optical biomarker may be an excitable fluorophore.

The first fluid chamber may be a microchannel.

The solid state membrane can include at least one nanopore, and, in some embodiments, a plurality of nanopores. The plurality of nanopores can be arranged in a circular or polygonal array.

According to another aspect of the invention, an optical microscopy tool for imaging single DNA molecules is disclosed that includes a fluid cell comprising a solid state membrane covering a window of a silicon wafer, a first fluid chamber on one side of the solid state membrane, a first fluid having a first refractive index in the first fluid chamber, a second fluid chamber on the other side of the membrane, and a second fluid having a second refractive index that is lower than the first refractive index in the second fluid chamber; a glass coverslip, the fluid cell mounted on the coverslip so that the glass coverslip forms a bottom surface of the first fluid chamber; an objective lens; an immersion oil between the objective lens and the glass coverslip; a light source configured to direct light at the objective lens, the objective lens configured to focus the light so that a field of evanescent illumination is generated that is smaller than the window that the solid state membrane covers; and an imaging detector to detect light emitted by the single DNA molecules at the solid state membrane.

The light source can include at least one excitation laser, and, in some embodiments, include a plurality of lasers producing laser beams at different wavelengths, and the imaging detector can include an electron multiplying charge coupled device (CCD) camera or a photodetector.

Biotin-streptavidin chemistry may be used to immobilize single DNA molecules on the solid-state membrane.

According to a further aspect of the invention, an optical microscopy tool for imaging single biomolecules is disclosed that includes means for generating a field of evanescent illumination at a solid state membrane between a first fluid and a second fluid having different refractive indices; and means for detecting light emitted by optical markers linked to the single biomolecules at the solid state membrane.

The means for generating the field of evanescent illumination at the solid state membrane may include an excitation laser and a focusing lens. The means for detecting light emitted by optical markers can include a photodetector or an electron multiplying CCD camera.

The optical microscopy tool may also include means for immobilizing the single biomolecules on the solid state membrane.

The field of evanescent illumination may be smaller than dimensions of the solid state membrane.

According to yet another aspect of the invention, a method for imaging a single biomolecule is disclosed that includes generating a field of evanescent illumination at a solid state membrane between a first fluid and a second fluid having different refractive indexes; and detecting light emitted by optical markers linked to the single biomolecules at the solid state membrane.

The method may also include immobilizing the single biomolecule on the solid state membrane.

Generating an image from the light detected.

According to a still further aspect of the invention, a method for imaging a single DNA molecule is disclosed that includes directing light to an objective lens of an optical microscopy tool; directing the light through a first fluid; reflecting the light at a silicon nitride membrane to generate a field of evanescent illumination in a second fluid; and directing light emitted by an optical biomarker excited by the field of evanescent illumination and linked to the single DNA molecule to an imaging detector.

The field of evanescent illumination may be generated in the second fluid. The single DNA molecule may be immobilized on the silicon nitride membrane in the second fluid.

### BRIEF DESCRIPTION OF THE FIGURES

FIG. 1 is a schematic diagram of a fluid cell according to one embodiment of the invention.

FIG. 2 is a perspective view of the interface of the fluid cell according to one embodiment of the invention.

FIG. 3 is a schematic diagram showing TIR at the interface according to one embodiment of the invention.

FIG. 4 is a schematic diagram of an optical microscopy tool according to one embodiment of the invention.

FIG. 5 is a fluorescent image of a single DNA molecule imaged under TIRF according to one embodiment of the invention.

FIG. 6 is a schematic diagram showing a DNA sequencing approach according to one embodiment of the invention.

FIG. 7 is a schematic diagram showing simultaneous electrical optical detection using one bit (a) and two bit (b) DNA readouts according to one embodiment of the invention.

FIG. 8 is a schematic diagram of a multi-color optical microscopy tool setup according to one embodiment of the invention.

FIG. 9 is a pore localization counter histogram according to one embodiment of the invention.

FIGS. 10A and 10B are illustrations of additional steps in multi-pore detection including simultaneous readout from multiple pores (FIG. 10A) and simultaneous readout of multiple bits (FIG. 10B) according to one embodiment of the invention.

FIG. 11 is a schematic diagram of the fluid cell according to one embodiment of the invention.

FIG. 11A is a detailed schematic diagram of the fluid cell of FIG. 11 according to one embodiment of the invention.

FIG. 11B is a detailed schematic diagram of the interface of FIG. 11 according to one embodiment of the invention

FIG. 12 is a fluorescent image of a single DNA molecule imaged under TIRF according to one embodiment of the invention.

FIG. 13 is a block diagram of analysis hardware according to one embodiment of the invention.

FIGS. 14A-C illustrate synchronization of electrical and optical signals according to one embodiment of the invention.

FIGS. 15A-15B illustrate threading of DNA molecules through a nanopore according to one embodiment of the invention.

FIGS. 16A-16B illustrate synchronization of the electrical and optical signals during the threading event of FIGS. 15A-15B.

FIG. 17 is a schematic diagram showing TIR at the interface according to one embodiment of the invention.

### DETAILED DESCRIPTION

Embodiments of the present invention relate to a method of imaging both single molecules as well as biological material through nanometer thick solid state membranes. This method is advantageous because it allows for optical (e.g. fluorescent) measurement, in addition to conventional electrical measurement, of single molecules and biological material. In one embodiment, a single molecule or biological material is imaged in evanescent mode through a thin solid state interface between two miscible/immiscible fluids. A fluid cell provides the solid state interface between the two miscible liquids of different refractive indices. The solid state interface can be on the order of a few nanometers to tens of nanometers in thickness and can be made of silicon nitride, silicon oxide and/or the like.

An electric potential can be applied to the two fluids for translocation of biomolecules (e.g., DNA, RNA or proteins) through a nanopore or nanopore array in the solid state interface. In DNA translocation, single-stranded DNA molecules are electrophoretically driven through the nanopore in a single file manner. In this embodiment, each base of the target DNA sequence is first mapped onto a 2 or 4 unit code, 2 10-20 bp nucleotide sequence by biochemical conversion. These 2-unit or 4-unit codes are then hybridized to complementary, fluorescently labeled, and self-quenching molecular beacons. As the molecular beacons are sequentially unzipped during translocation through the nanopore, their fluorescent tags are unquenched and are read by a single-color, or multi-color (e.g. 2 or more color) total internal reflection fluorescence (TIRF) microscope. The resulting single-color or multi color optical signal is then correlated to the target DNA sequence.

Embodiments of the present invention are advantageous because they allow for the acquisition of high resolution and high sensitivity images of single biomolecules or biological material immobilized on the solid-state interface, positioned over a “thick” aqueous fluid layer (i.e., high refractive index fluid). More specifically, by realizing an evanescent field deep inside this “thick” fluid layer, high optical contrast detection of molecules or biological material at the thin solid-state interface can be used to image the single biomolecules or biological material.

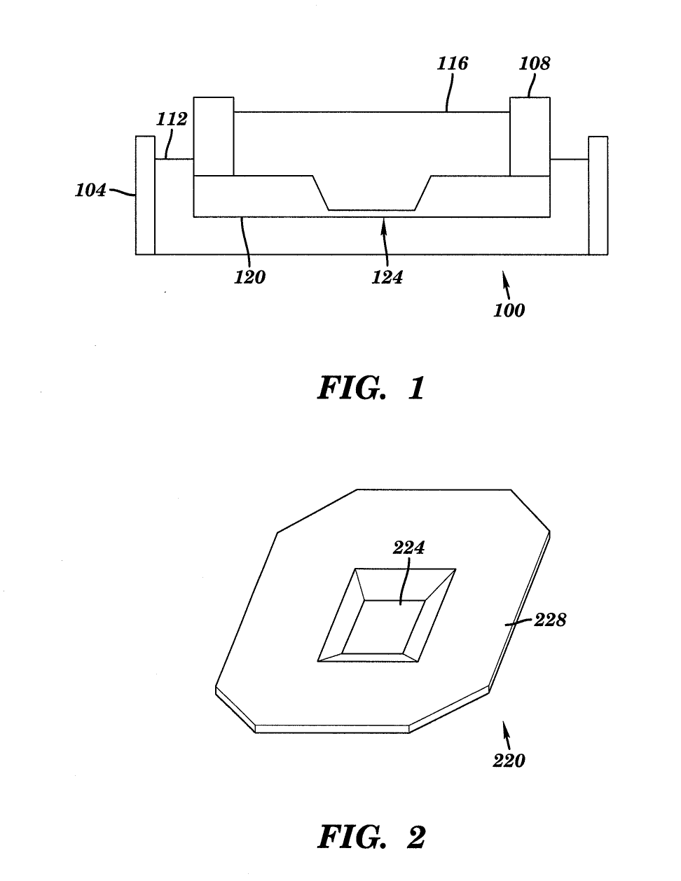

FIG. 1 illustrates a fluid cell according to an embodiment of the invention. As shown in FIG. 1, the fluid cell 100 includes a first chamber 104 and a second chamber 108. A first fluid 112 is in the first chamber 104 and a second fluid 116 is in the second chamber 108. The two fluids 112, 116 are chosen so that they have different refractive indices. The first fluid 112 is selected to have a higher refractive index than the second fluid 116. The refractive indices of the two fluids 112, 116 are chosen so as to achieve total internal reflection (TIR) at the interface 120. For example, the first fluid 112 may be cytoplasm (n=1.36) or cell membrane (n=1.47) and the second fluid 116 may be an aqueous buffer solution (n=1.33). In another example, the first fluid 112 contains salts. Both fluids 112, 116 are aqueous solutions.

The fluid cell 100 also includes an interface 120. The interface 120 includes a solid state membrane 124. The interface 120 is located between the first chamber 104 and the second chamber 108 to separate the two fluids 112, 116. The interface 120 between the two fluids 112, 116 allows total internal reflection (TIR) to occur. In particular, the TIR illumination occurs at the solid state membrane (e.g., a SiN membrane) 124 and produces an evanescent wave in the first chamber 104. The interface 120, and in particular the membrane 124, forms the substrate for biomolecular interactions.

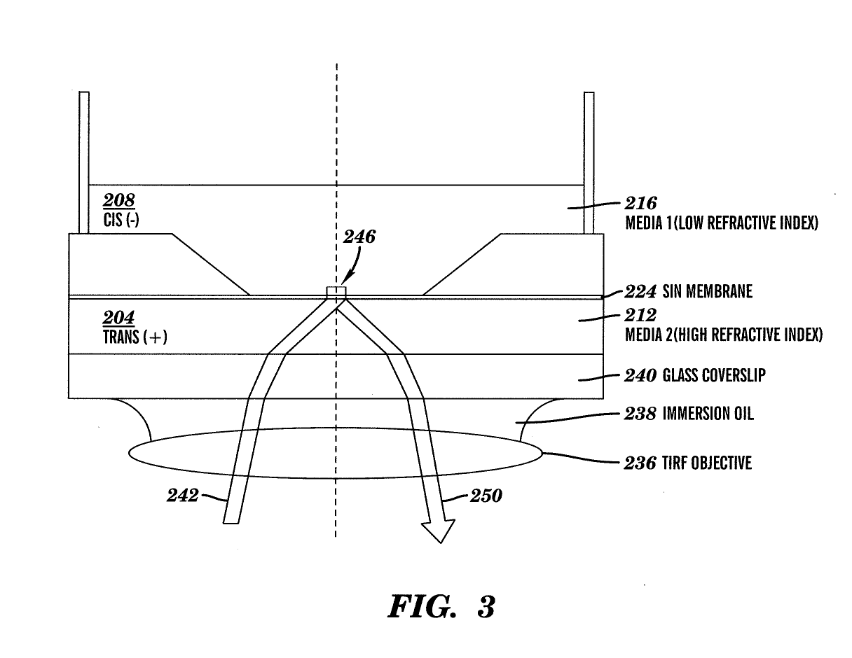

FIG. 2 is a detailed view of the interface 120. As shown in FIG. 2, the interface 220 includes a chip 228 with a window 224. The chip 228 acts as a frame to support the solid-state membrane that covers the window 224. Exemplary dimensions of the chip can be 5 mm×5 mm×300 μm, and exemplary dimensions of the membrane can be 50 μm×50 μm×5-50 nm. The interface 220 can be made from any compatible solid state material (e.g., silicon based materials) using conventional techniques including chemical vapor deposition (CVD), wet etching and photolithography.

In one embodiment, the chip 228 is silicon and is covered by a silicon nitride membrane. It will be appreciated that the membrane may be any dielectric material that can be formed into a thin film. Other exemplary membrane materials include silicon oxide, aluminum oxide, titanium oxide and the like. Other exemplary chip materials include glass, fused silica, quartz and the like.

The solid-state membrane described herein can be approximately 5-60 nm in thickness. For example, the solid-state membrane may be approximately 10 nm. It will be appreciated, however, that the thickness of the membrane can be selected in order to obtain the desired size and decay of the evanescent wave produced from the TIR illumination between the two miscible liquids, and may be thinner than 5 nm or thicker than 60 nm. The nanometer thickness of the membrane helps define a sharp boundary of interface between the two liquids where the TIR occurs.

It will be appreciated that in some embodiments the solid-state membrane may include nanopores, nanoslits or nanopore arrays. These nanopores (1-100 nm) or nanopore arrays connect the fluids across the interface. Solid-state nanopores have tunable dimensions, and can tolerate a broad range of temperature, pH, and chemical variation. The nanopore(s) can be fabricated using, for example, Ar ion beam or electron-beam sculpting, or by reactive ion etching.

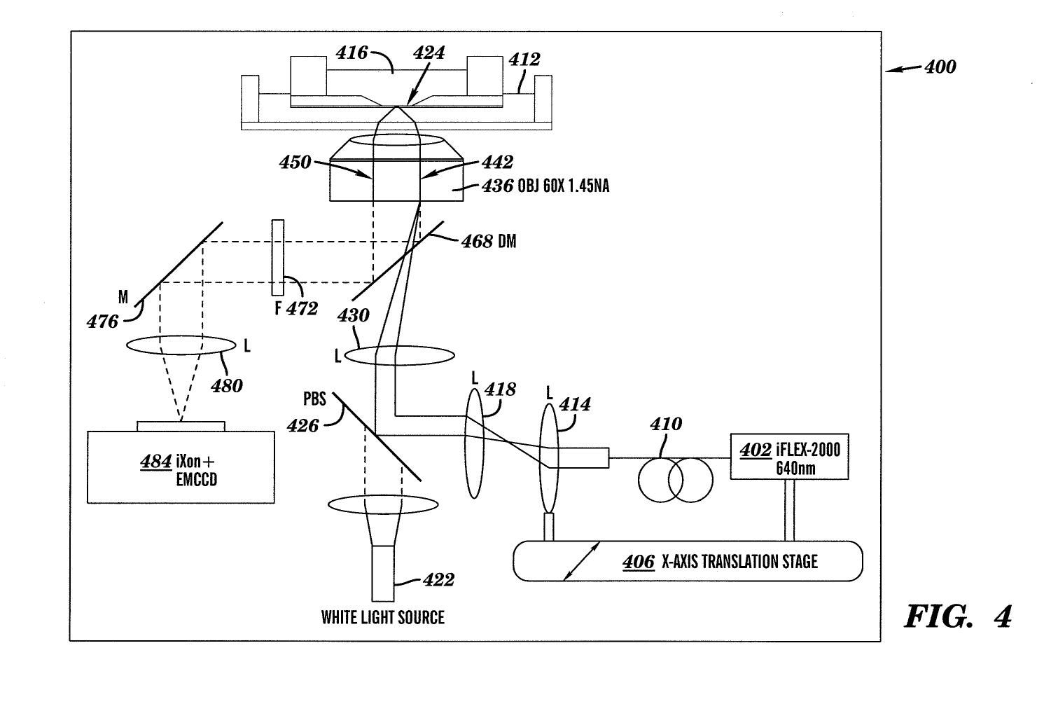

FIG. 3 illustrates the fluid cell 100 mounted on a regular microscope glass coverslip 240 for TIR based measurement with an optical microscopy tool. The coverslip 240 is mounted on an objective lens 236, and an immersion oil 238 is provided between the coverslip 240 and the objective lens 236. One or more biomolecules or biological material that are linked to an optical biomarker, such as a fluorophore, are immobilized on the membrane 224 for imaging.

The optical biomarker can be any material that illuminates or emits radiation in response to exposure to the evanescent wave. Exemplary optical biomarkers include fluorescent propanes or fluorescence resonance energy transfer (FRET) tags (e.g., a fluorophore), quantum dots and organic compounds. As one of ordinary skill would appreciate, the optical biomarker can be associated with the biomolecules of interest by well known techniques, for example, by covalent or non-covalent associations. In one embodiment of the invention, the optical markers can be chemically conjugated. In an alternative embodiment of the invention, the biomolecule can be associated with an optical marker by recombinant fusion, e.g. green fluorescent protein fused to a cellular receptor or signaling molecule.

Laser light 242 is focused at the back focal plane of an objective lens 236. Due to index matching of the immersion oil 238 and the glass coverslip 240, light refracts into media 1 216. At the membrane 224, the light is totally internally reflected 246 due to the unmatched refractive indices of the two liquids 212, 216. Light refracts away from the normal to the surface when it passes from a higher refractive index (denser) to a lower refractive index (rarer) medium. When the angle of incidence at the interface of the two medium is larger than the critical angle, light totally internally reflects back into the denser medium. An evanescent wave 246 is generated in the rarer medium that has an exponentially decaying intensity which can excite fluorophores at the surface of the membrane 224 (typical “skin” depth of excitation light is on the order of a few tens of nm). The light produced by the excited fluorophores 250 can be focused by the objective lens 236 that is positioned below the glass coverslip 204 and measured by the imaging device, e.g. CCD camera or photodetector.

In one embodiment, the light is generated so that the area of evanescent wave 246 is smaller than the area of the membrane 224. In another embodiment, the light is generated so that the area of the evanescent wave 246 is the same size as the area of the membrane 224.

It will be appreciated that in some embodiments the nanopores, nanoslits or nanopore arrays in the membrane can be used to locally stimulate live cell surfaces using a variety of stimulants. Response to these stimuli can be measured at distal locations on the cell membrane using the evanescent mode imaging described herein.

The biomolecules or biological material (e.g., cells) can be positioned directly on the membrane 224 to be imaged. Alternatively, a thin buffer or intermediate layer may be provided between the membrane 224 and the biomolecules or biological material to be imaged. For example, a thin layer of organic polymer molecules may be used as the intermediate layer.

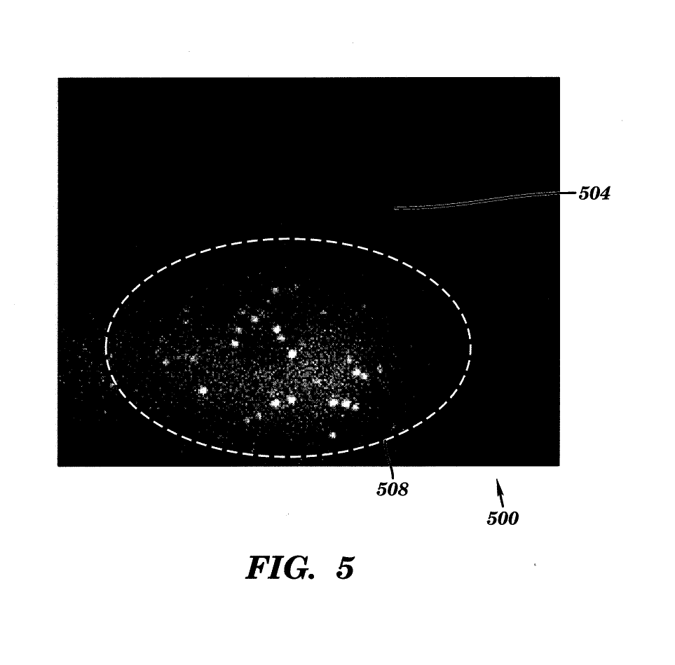

FIG. 4 illustrates an exemplary optical microscopy tool 400 according to embodiments of the invention. It will be appreciated that the components and arrangement of the components of the microscopy tool 400 may vary from that shown in FIG. 4. The microscopy tool 400 includes a laser source 402, an x-axis translation stage 406, lens 414, lens 418, a white light source 422, a polarizing beam splitter (PBS) 426, a lens 430, an objective lens 436, a dichromatic mirror (DM) 468, a filter 472, a mirror 476, a lens 480 and a detector 484 such as a CCD. A fluid cell, including a first fluid 412, a second fluid 416 having a different refractive index than the first fluid 412, and a solid-state membrane 424, is positioned on a glass coverslip 440. Immersion oil is provided between the glass coverslip 440 and the objective lens 436.

In the illustrated microscopy tool 400, laser light or white light may be used to perform total internal reflection fluorescence microscopy. In one embodiment, laser light 410 is generated by the laser source 402, which is directed and shaped by the lenses 414, 418. The lens 430 is configured to reduce the size of the laser beam. It will be appreciated that lens 414, 418 may also reduce the size of the laser beam. The light may be shifted off the optical axis by moving the laser fiber coupler along the x-axis using the x-axis translation stage 406. In another embodiment, white light is generated by the white light source 422. In yet another embodiment, both white light and laser light can be used to perform total internal reflection fluorescence microscopy. The beam splitter 426 is configured to direct the light generated by the laser and/or the white light source 422 toward the sample (e.g., biomolecule(s)) in the first fluid 412. In yet another embodiment, multiple laser wavelengths can be used simultaneously or one at a time, to excite a single-color or multiple color fluorophores.

After passing through lens 430 and a dichromatic mirror 468, the generated light is confined at the objective lens 436 so that light sufficient to result in total internal reflection is directed at the sample. It will be appreciated that the objective lens 436 can further reduce the size of the laser beam. It will be appreciated that the laser beam size may be approximately 0.5 mm-1 mm in diameter. The lenses 414, 418, 430 and/or 436 converge the beam such that the beam creates a sot size at the silicon membrane of approximately 5 μm to approximately the area of the membrane 424 in diameter. For example, if the membrane 424 is 50×50 μm², a spot size of 5-50 μm can be generated.

The light 442 is totally internally reflected at the solid-state membrane 424 toward the glass coverslip 440, and an evanescent field is generated in the second fluid 416. Fluorophores located in the vicinity of the solid-state membrane 424 are excited by the evanescent wave, which causes the fluorophores to emit fluorescent light. The fluorescent light and reflected light 452 are then directed by the dichromatic mirror 468 toward the filter 472. The dichromatic mirror 468 and filter 472 filter the light so that only the fluorescent light emissions are passed. The mirror 476 directs the fluorescent light through the lens 480 and to the detector 484.

The detector 484 can be a EMCCD camera, such as an iXon BV887 available from Andor Technology plc. (Andor) based in Belfast, Northern Ireland. Other exemplary detectors 484 include Avalanche Photodiodes (APDs) and Photomultiplier Tubes (PMTS). The detector 484 can be connected to an appropriate imaging system, such as a Microsoft Windows based personal computer and imaging software, such as Solis software (also from Andor) to process the data signals generated by the detector 484 to produce an image or a series of images. Custom software can be us to analyze the data signals, detect the fluorescent emissions and determine the sequence or other characteristics of the biomolecules or biological material under examination.

It will be appreciated that the area of TIR excitation at the interface depends on the excitation beam properties. The laser beam can be shaped, using well known laser beam shaping techniques, to control the field of laser illumination in TIR mode. Thus, the size of the beam can increased or decreased in diameter or elongated as desired.

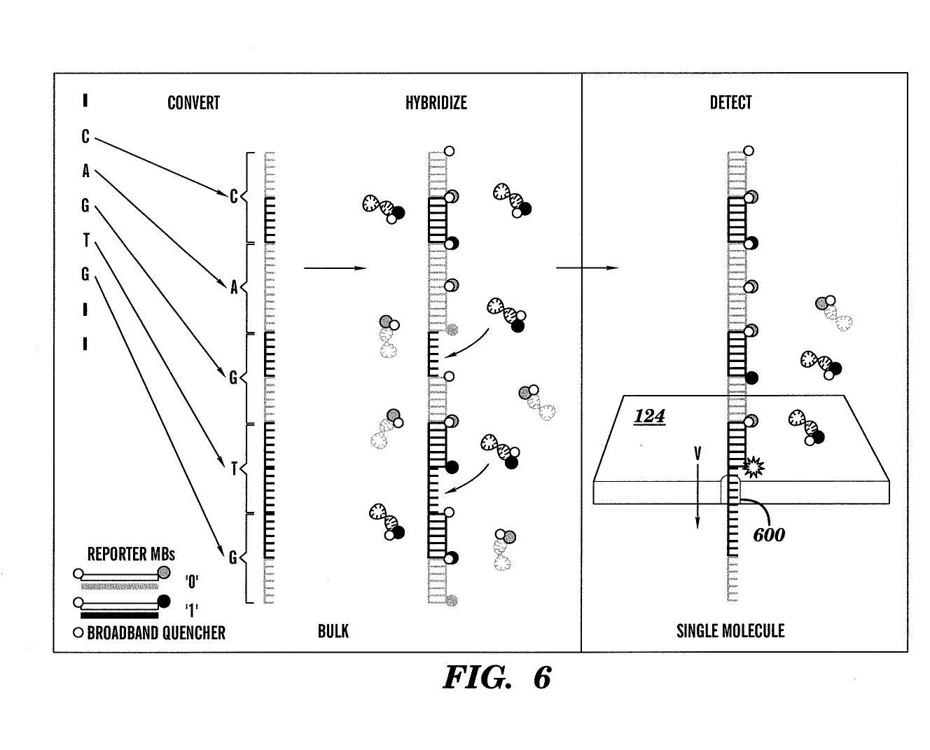

FIG. 5 illustrates an exemplary image generated using a microscopy tool such as the microscopy tool 400. In FIG. 5, the field of view of TIRF illumination 504 of an exemplary sample is shown. FIG. 5 also illustrates single fluorescent DNA molecules 508 that were imaged using the microscopy tool imaged with two representative fluids, specifically 7M CsCl (n=1.416) and 8M Urea (n=1.416). It will be appreciated, however, that other fluids may be used to image single biomolecules in accordance with embodiments of the invention. In FIG. 5, the single DNA molecules were imaged on the silicon nitride membrane with a signal to background ratio of ˜2.5 at image acquisition of 5 frames per second.

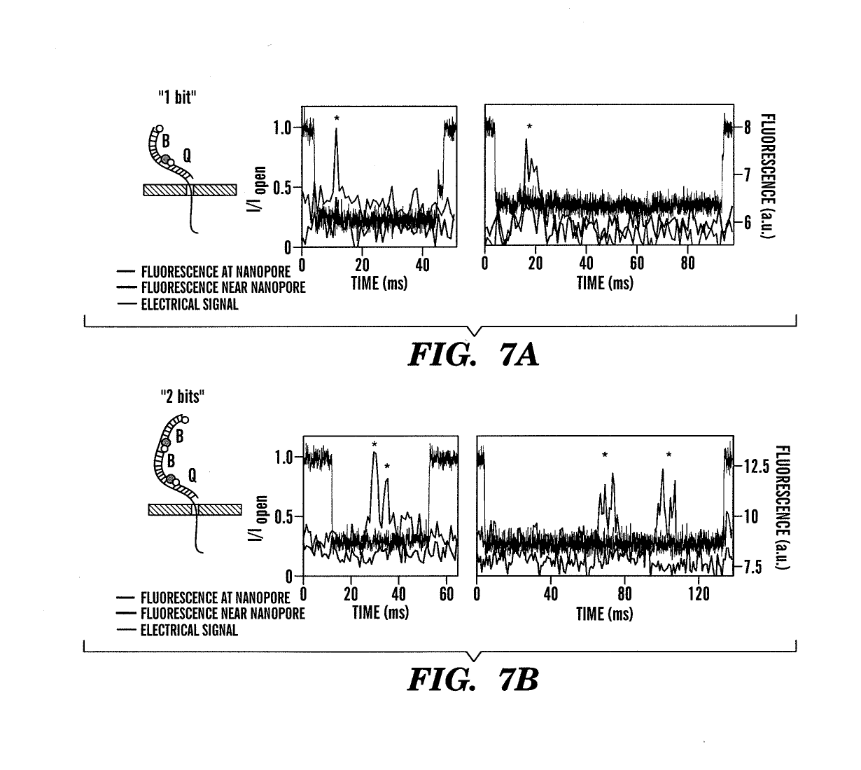

FIGS. 6-10B illustrate an embodiment of the invention in which the membrane 124 includes a nanopore 600. As shown in FIG. 6, embodiments that include a membrane 124 having a nanopore 600 are particularly applicable to DNA sequencing using DNA translocation. It will be appreciated that the embodiment that includes a membrane 124 having a nanopore 610 are not limited to DNA sequencing using DNA translocation. For example, the embodiment may be applicable to genotyping applications, biomolecular imaging and biomolecular screening. In another example, proteins may be imaged through the nanopore 600.

In DNA translocation, single-stranded DNA molecules are electrophoretically driven through the nanopore 600 in a single file manner. It will be appreciated that in these embodiments the fluid cell 100 will further include electrodes coupled to an energy source that are configured to generate an electric potential that is applied to the fluids 112, 116 to electrophoretically drive the DNA molecules through the nanopore 600.

In FIG. 6, the single biomolecule linked to an optical marker to be detected is an oligonucleotide that hybridizes to a sequence code representative of nucleotides A, T, U, C, or G. In one embodiment, the optical markers are fluorescent markers that specifically report on the DNA sequence. In one exemplary labeling procedure the original DNA is substituted with a group of nucleotides (each base type is substituted with a unique sequence of 3-16 nucleotides). The oligonucleotide linked to the optical marker can then be detected upon unzipping of the hybridized oligonucleotide from a coded nucleic acid sequence to be sequenced during nanopore sequencing.

For example, in one DNA conversion procedure, each base in the original DNA sequence is represented by a unique combination of 2 binary code units (0 and 1 labeled in open and solid circles, respectively). In this case, the 0 and 1 are defined as unique DNA sequences of 10 nucleotides each, “S0” and “S1” respectively. The single-stranded converted DNA is hybridized with two types of molecular beacons complementary to the 2 code units, and displays minimal cross-sections. For example, one of the beacons may contain a red fluorophore on its 5′ end and a quencher, Q, at its 3′ end, and the other beacon may contain a green fluorophore at its 5′ end and the same quencher molecule at its 3′ end. The broad-spectrum quencher molecule Q quenches both fluorophores. The 2 different color fluorophores make it possible to distinguish between the two beacons. In another DNA conversion procedure, each base in the original DNA sequence is represented by one out of four unique codes (sequences), which are then hybridized with the corresponding 4-color molecular beacons. In both procedures, the converted DNA sequence induces the arrangement of the beacons next to each other so that quenchers on neighboring beacons will quench the fluorescence emission and the DNA will stay “dark” until individual code units are sequentially removed from the DNA (excluding the 1^{st} beacon). Examples of fluorophores that can be used with the present invention include TMR and Cy5. Other types of fluorescent molecules that can be used are CPM, the Alexa series of fluorescence markers from Invitrogen, the Rhodamine family, and Texas Red. Other signal molecules known to those skilled in the art are within the scope of this invention. Numerous other fluorophores can be used in the present invention including those listed in U.S. Pat. No. 6,528,258, the entirety of which is incorporated herein by reference. Quenching molecules that can be used in the present invention include Dabcyl, Dabsyl, methyl red and Elle Quencher. Other quencher molecules known to those skilled in the art are within the scope of this invention. This significantly reduces the fluorescence background from neighboring molecules and from free beacons in solution, resulting in a higher signal-to-background ratio.

Referring back to FIG. 6, fluorescently tagged oligonucleotides, complementary to the converted DNA, are then hybridized to the DNA and the molecule is electrophoretically fed through the nanopore 600 in the membrane 124. The nanopore 600 is used to sequentially peel off oligonucleotides, one by one, from the converted DNA molecule while the flashes of light in different colors arising from the attached fluorophores are detected. When the molecule is introduced to the nanopore, the beacons are stripped off one by one. Each time a new beacon is removed, a new fluorophore is unquenched and registered by the microscope. The released beacon is automatically closed, quenching its own fluorescence, whereupon it diffuses away from the vicinity of the nanopore. Immediately upon the release of the first beacon, a new fluorophore from the second beacon lights up.

The DNA translocation speed is regulated by the DNA unzipping kinetics, and the contrast among bases is achieved through the use of optical probes (or beacons). The entry of the DNA into the nanopore 600 abruptly decreases the ion current to the blocked level. When the DNA exits from the other side, the open pore current level is restored. An appropriate voltage can be used to tune the DNA unzipping time (e.g., 1-10 ms). For example, for a 10-bp hairpin, a 120-mV potential yields an unzipping time of approximately 10 ms. This time is tuned by the electric field intensity to optimize the signal-to-background levels.

In such a manner, the sequence of any nucleic acid can be determined. Detailed descriptions of the conversion of a nucleic acid to be sequenced to a coded sequence, coding systems and nanopore sequencing can be found in Soni and Meller (Soni G. V. and Meller A., Progress towards ultrafast DNA sequencing using solid-state nanopores, Clinical Chemistry 53, 11 (2007)), Meller et al., 2009 (U.S. Patent Application publication 2009/0029477), and Meller and Weng (PCT Application No. PCT US 2009/034296). These references are incorporated herein by reference in their entirety. It will be appreciated that this method can be used in parallel through nanopore arrays.

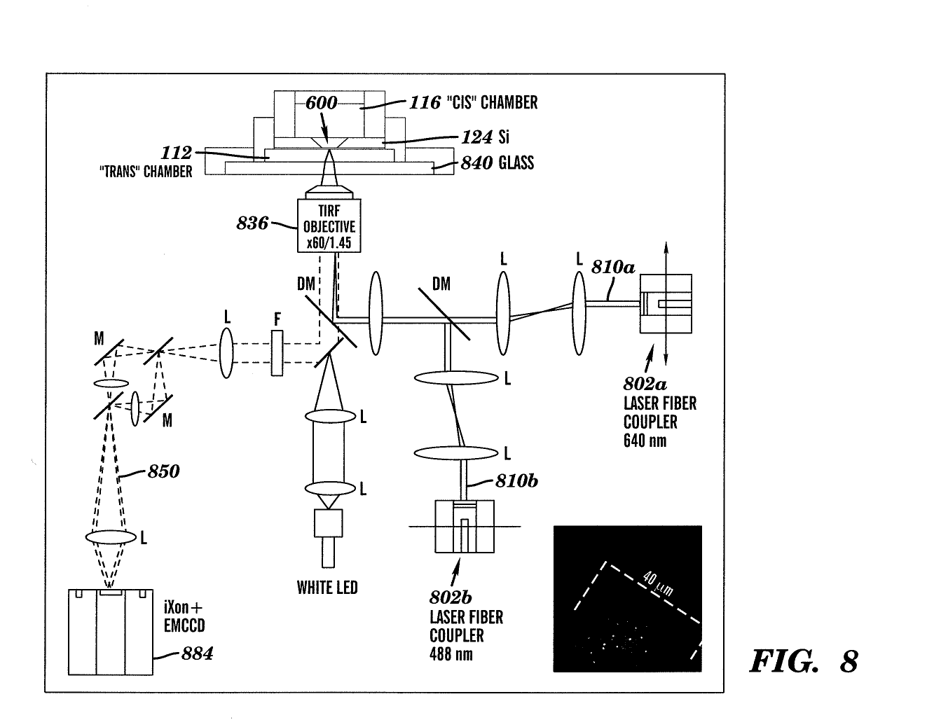

FIG. 7 illustrates nanopore sequencing color coded using 1 bit in (a) and “2 bits” in (b). As shown in FIG. 7, the devices and methods described herein allow for simultaneous electrical and optical detection of one and two bit DNA readouts with high signal/noise ratio and with single fluorophore resolution is shown.

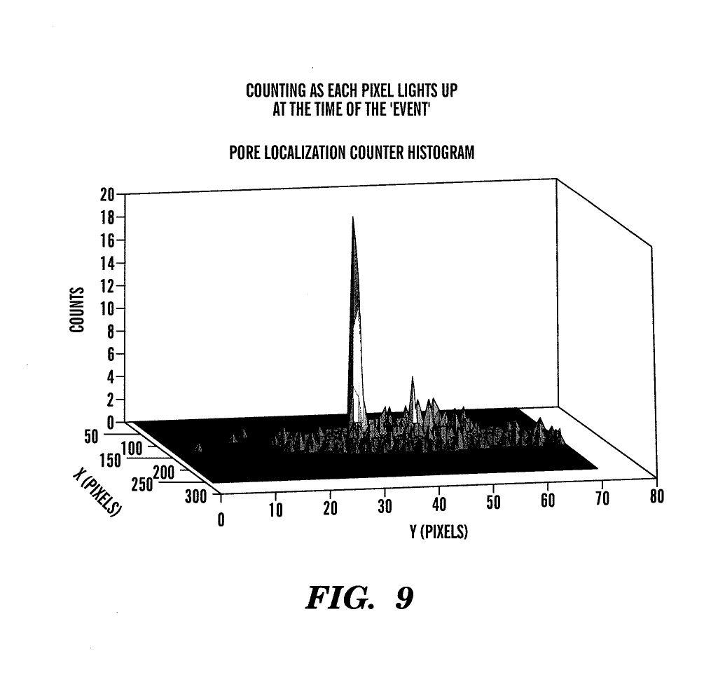

The 2-bit color coding may be achieved using a multi-color optical microscopy tool such as the multi-color TIRF microscope shown in FIG. 8. In the embodiment shown in FIG. 8, two laser sources 802a, 802b of different wave lengths can be illuminated either individually or simultaneously to produce two evanescent waves of different wave lengths for individual or simultaneous excitation of different optical biomarkers. Similarly, for a 3 or more-color code system three or four laser sources of different wave lengths can be illuminated either individually or simultaneously to produce three or more evanescent waves of different wave lengths for individual or simultaneous excitation of different optical biomarkers.

As shown in FIG. 8, a first laser source 802a generates a first laser beam 810a and a second laser source 802b generates a second laser beam 810b that are shaped and directed to the objective lens 836 by lenses L. The lenses L are configured to reduce the size of the laser beams 810a, 810b generated by the laser sources 802a, 802b. In one embodiment, the laser sources 802a, 802b are a combination of blue and red diode lasers (488 nm and 640 nm) may be used to illuminate the sample. As described above with reference to FIG. 4, the light 802a, 802b is totally internally reflected at the membrane 124 and an evanescent field is generated that excites the fluorophores linked to the biomolecules to be imaged in the fluid cell. In the embodiment shown in FIG. 8, the membrane 124 includes a nanopore 600 that allows for DNA translocation as described above.

The fluorescent light 850 is then collected using the objective lens 836, filtered by a dichromatic mirror DM and filter F, and directed to the detector 884, such as a frame transfer cooled electron-multiplying charge-coupled device camera for imaging or photodetector. The detector 884 can be connected to an appropriate imaging system, such as a Microsoft Windows based personal computer and imaging software, such as Solis software (also from Andor) to process the data signals generated by the detector 884 to produce an image or a series of images. Custom software can be used to analyze the data signals, detect the fluorescent emissions and determine the sequence or other characteristics of the biomolecule (e.g., DNA) under examination.

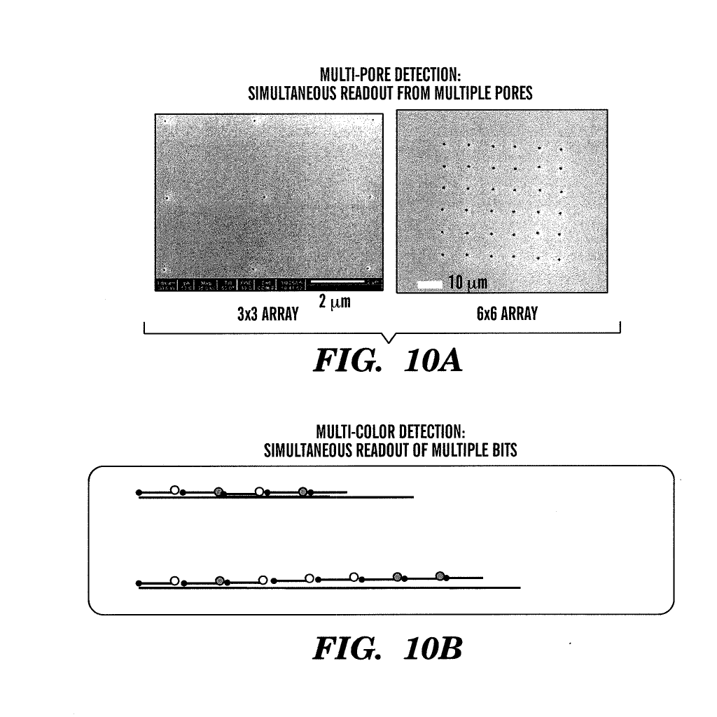

FIG. 9 illustrates an exemplary pore localization counter histogram for the multi-color optical microscopy tool of FIG. 8 at the time of DNA unzipping.

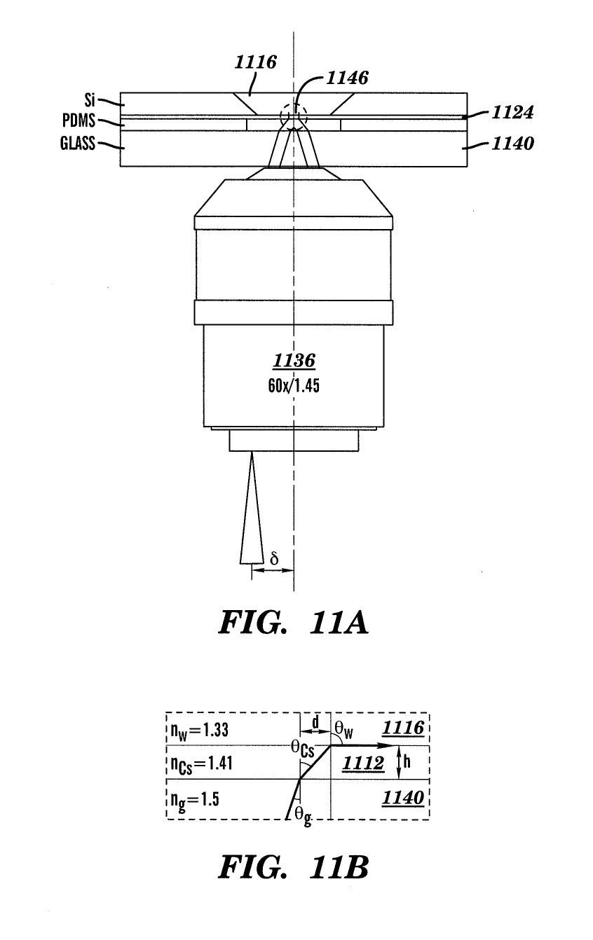

It will be appreciated that optical visualizations of nanopore arrays may also be achieved using the embodiments described herein. For example, the optical visualization described herein can be used for the simultaneous readout from multiple pores as shown in FIG. 10A and/or the simultaneous readout of multiple bits as shown in FIG. 10B.

Embodiments of the invention may also be used to visualize cell and tissue adhesion to study cyto-toxicity and biocompatibility with solid state materials such as, for example, the SiN membrane.

Embodiments of the invention may also be used to locally excite cells with stimulants in media across the interface through nanopores, nanoslits or nanopore arrays and to measure cell response using optical microscopy through the membrane. The cell response to contact with new biomaterials (such as SiN membranes) or to stimulants can be measured with fluorescent readout of biomarkers on the cell membrane.

Embodiments of the invention may be used to image fluorescently labeled nucleic acids or other biopolymers, with single molecule resolution, during their transit or temporal lodging in a nanopore fabricated in the solid-state membrane.

Embodiments of the invention may also be used to detect stochiometry of fluorescently labeled proteins stoichiometrically bound on biopolymers such as DNA translocating or temporarily lodged in a nanopore.

Embodiments of the invention may be used for multi-color detection and, may, therefore be used to detect spatial localization of biologically distinct proteins bound on DNA.

Embodiments of this invention may be used for DNA sequencing through nanopores and high throughput drug screening.

It will be appreciated that the size of the field of TIR illumination can be changed depending on the application by changing the beam diameter and/or shape of the incident laser beam.

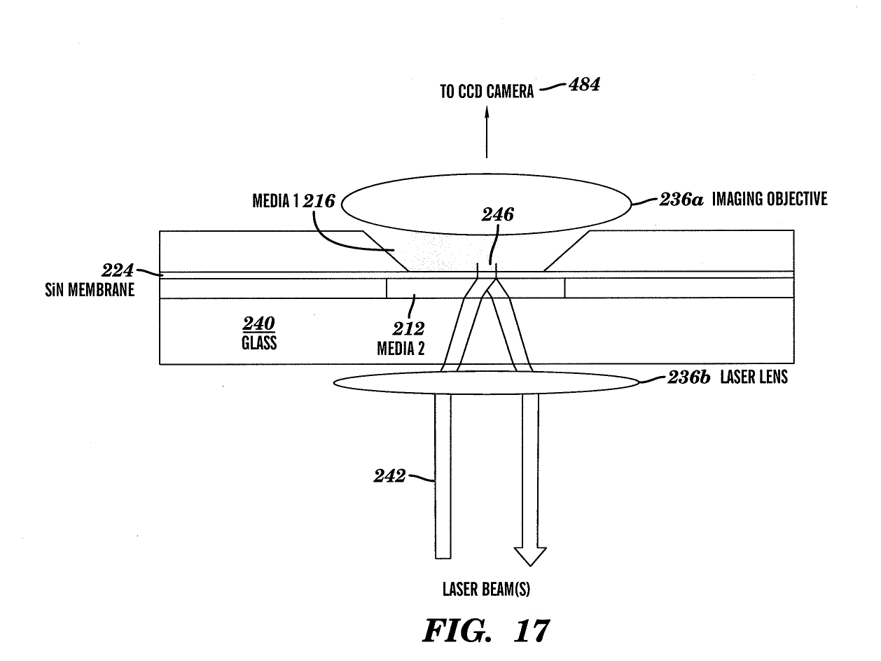

In one embodiment, as shown in FIG. 17, the objective lens 236a can be placed above the cis chamber 208, rather than below the trans chamber 204, and the objective lens 236a can be used for imaging. In this configuration, the laser beam 242 can be focused using a lens 236b rather than the objective lens 236a at the membrane 224. As described above with reference to FIG. 3, due to index matching of the immersion oil 238 and the glass coverslip 240, light 242 from the laser (via lens 236b) refracts into media 1 216. At the membrane 224, the light is totally internally reflected 246 due to the unmatched refractive indices of the two liquids 212, 216, and an evanescent wave 246 is generated in the rarer medium, media 1 216 that has an exponentially decaying intensity which can excite fluorophores at the surface of the membrane 224 (typical “skin” depth of excitation light is of a few tens of nm). The light produced by the excited fluorophores can be focused by the objective lens 236a that is positioned over the cis chamber 208 and measured by the CCD camera 484 or photodetector.

### EXAMPLES

### Example 1

### Sample Geometry

Silicon chips [5 mm×5 mm×300 μm] with a free standing 20-50 nm thick silicon nitride window [50 μm×50 μm] in the centre were made by standard photolithographic methods on LPCVD coated SiN layers on silicon wafers. A two-part PTFE/CTFE fluid cell was designed to mount these chips over a glass coverslip forming a 2-10 μm thick microchannel between the chip and glass coverslip, as shown in FIG. 3. The microchannel, trans chamber 204, was filled with fluid of a higher refractive index (70% glycerol [n=1.42]) and the cis chamber 208 was filled with a sample solution buffer in water [n=1.33].

### TIRF Setup and Ray Diagram

Total internal reflection [TIR] microscopy was setup as shown in FIG. 4. The laser beam size was reduced to 0.7 mm, launched into the custom designed back port of a commercially available inverted microscope (Olympus IX-71) and focused at the back focal plane of a 60× 1.45 NA oil-immersion TIRF objective via an externally mounted 200 mm focal length lens. The laser point was shifted off the optical axis by moving the laser fiber coupler along the X-axis. The refractive indices of glass [n=1.52], 70% glycerol [n=1.42] and sample buffer [n=1.33] were chosen such that the light refracted through the oil, glass coverslip and 70% glycerol in the trans chamber until it reached the glycerol-water interface at the silicon nitride membrane. The critical angle for TIR mode at this interface is the same as the glass-water interface as described by Snell's law,

n_{glass} sin(θ_{glass})=n_{gly} sin(θ_{gly})=n_{w} sin(θ_{w})

where, n represents the refractive indices of glass, glycerol 70% or water, and θ is the angle of incidence at the respective interfaces. The centre of the field of view is shifted in the direction of light propagation depending on the thickness of the high refractive index fluid layer. Fluorescence emission was 3× magnified by external lenses and was collected by the same objective and imaged on a commercially available EMCCD camera (Andor iXon BV887) after passing the appropriate optical filters. Imaging was done by the vendor provided Andor Solis software or using custom written software.

### Sample Immobilization

DNA molecules [57 bp] were purchased from IDT Tech with biotin conjugation at 5′end with amine modified thymine base at position 20 from 5′ end. The DNA molecules were labeled with ATTO647N dye molecules [ATTO-tech] using the vendor's protocols. The DNA molecules were immobilized on the silicon nitride surface by streptavidin-biotin chemistry. The surfaces were cleaned in a freshly prepared Piranha solution (15 minutes in 7:3 v/v solution of sulfuric acid and hydrogen peroxide) and then copiously rinsed in DI-water. Surfaces were incubated overnight in 0.1 mg/ml BSA-biotin, rinsed with binding buffer [10 mM Tris-Cl pH8.5], incubated in 0.1 mg/ml of streptavidin for 30-60 min, rinsed in binding buffer and then incubated with biotin labeled DNA for 15-30 minutes. The surfaces were then mounted in the fluid cell. The 70% glycerol was filled in the trans microchannel between the glass coverslip and the silicon chip, and binding buffer was filled in the cis chamber. The surfaces were then imaged by TIRFM at the silicon nitride interface.

### Results

The silicon nitride membrane (e.g., 20×40 μm² in size and 20 nm in thickness) was mounted on a glass coverslip as shown in FIG. 4. The two fluids in trans and cis chambers, respectively, were chosen to be glycerol 70% (v/v) (n=1.42) and water (n=1.33).

The excitation laser beam was shaped to form a field of evanescent illumination smaller than the dimensions of the membrane as shown in FIG. 5. By reducing the beam diameter to 0.7 mm, the spot size was smaller than the SiN membrane size.

Light that entered the objective lens (n=1.55) propagated through the immersion oil (n=1.52), glass coverslip (n=1.55), liquid 2 (70% glycerol) (n=1.42), across the interface and finally water (n=1.33). The light underwent total internal reflection at the interface which separated the glycerol from the water.

To calibrate the excitation field geometry, 20 nm TMR beads were adsorbed on the cis side of the membrane and imaged in TIRF mode. By moving these TMR beads along the X and Y axis, and using the magnification factor of the imaging optics, the field of evanescent illumination was calculated to be about ˜10×20 um².

In the example, single DNA molecules biotinylated at 3′ and ATTO647N labeled at 5′ were immobilized on the cis side of the silicon nitride surface using biotin-streptavidin chemistry (i.e., methods and materials).

### Example 2

### TIRF Setup

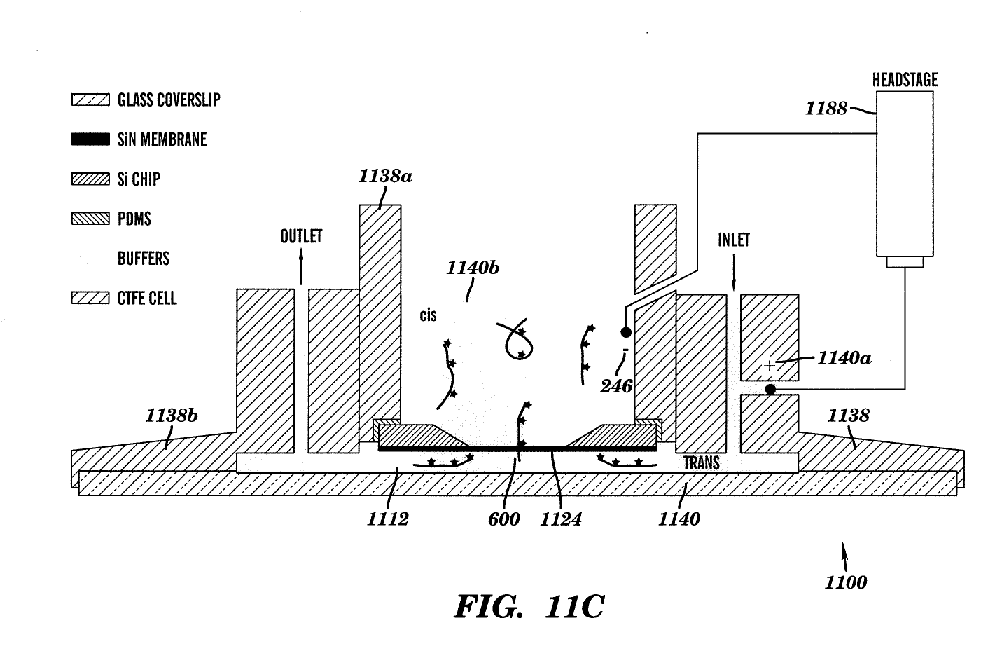

In the experiment, a silicon chip 1128 containing a free-standing SiN membrane (20×20 μm²) 1124 having a nanopore 600 was used as the interface. The silicon chip 1128 was mounted on a glass coverslip 1140, which was mounted on a custom made chlorotrifluoroethylene (CTFE polymer) fluid cell 1138 to create a micro fluidic trans chamber 1100 as shown in FIG. 11. The fluid cell 1138 included an insert 1138a holding the silicon chip 1128 and an outer cell 1138b to form the fluidic chambers. Thin layers of fast curing polydimethlysiloxane (PDMS) were used to bond the silicon chip 1128 to the CTFE insert 1138a and bond the glass coverslip 1140 to the outer cell 1138b. The fluid chamber having the insert 1138a is the cis chamber, and the space between the silicon chip 1128 and the glass coverslip 1140 is the trans chamber. The trans chamber was filled with a refractive index buffer 1112 using the inlet-outlet flow channels. For electrical measurements, a trans electrode 1140a was provided in the side opening in the flow channel and a cis electrode 1140b was immersed into the buffer in the insert (both Ag/AgCl) 1116. The nanopore 600 was used to align the fluid cell 1100 to the inverted microscope 1136 for optical visualization and measurements, as shown in FIG. 11A.

The refractive indices of the buffer used in the cis chamber, n_{w}≈1.33, (water buffer, 1M KCl and 10 mM tris, pH of 8.5) and trans chamber (aqueous buffer solution having high index of refraction n_{Cs}) were smaller than the glass index of refraction n_{g}=1.5 (n_{w}<n_{Cs}<n_{g}). In particular, a salt buffer solution containing 7M CsCl and 10 mM tris, pH of 8.5 (“Cs7M,” n=1.41) was used as the buffer in the cis chamber.

A parallel beam of light was introduced from the glass coverslip side at an angle θ_{g} smaller than the critical angle of reflection of the glass/trans chamber interface but slightly larger than the trans/cis critical angle creating a TIR excitation at the SiN membrane as shown in FIG. 11B. A high numerical aperture (NA) objective (Olympus 60×/1.45) was used to achieve TIR by focusing the incident laser beam to an off axis point at its back focal plane (d), thus controlling the angle of incidence θ_{g}. The in-plane location of the TIR excitation region is displaced by a distance d=h tan(θ_{Cs}), where h is the height of the trans chamber.

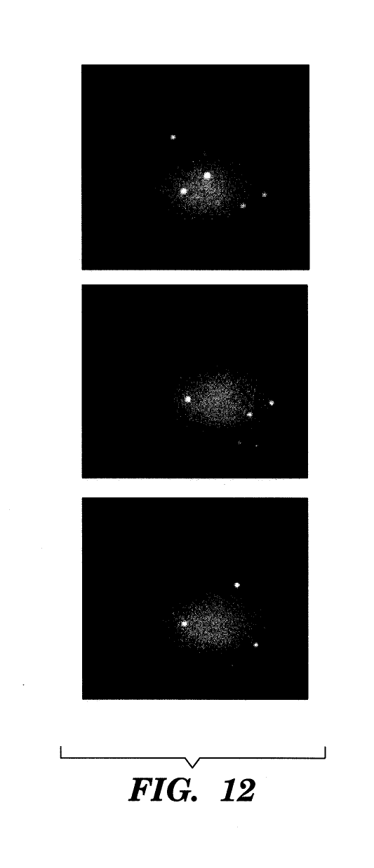

The incident laser beam width was shaped using a long focal length achromatic doublet lens (200 mm) such that the illuminated area on the SiN membrane was approximately 10×20 μm². A 640 nm laser (20 mW) (iFlex2000, Point-Source, Hamble, UK) was coupled to the system through a single-mode polarization-preserving optical fiber, producing a collimated Gaussian laser beam with a diameter of 0.7 mm. This high quality beam ensured a tightly focused spot at the objective entrance, thus minimizing undesired scattering. The cis side of the membrane surface was coated with streptavidin using common procedures. Short biotinylated DNA oligos, each labeled with a single ATTO647N fluorophore, were immobilized on the membrane surface and imaged by projecting the fluorescence light onto the electron multiplying CCD camera, working at maximum EM gain and 10 ms integration. An electron multiplying charged coupled device (EMCCD) camera (Andor, iXon DU-860) was used to record fluorescence images from the membrane surface. FIG. 12 displays three typical images of single molecules immobilized on the membrane surface imaged under TIRF according to one embodiment of the invention. As shown in FIG. 12, single fluorophores are resolved with high contrast requiring no further image processing.

As the incident angle is increased, the critical angle for TIR causes (1) the abrupt disappearance of the laser light observed from the cis side of the membrane, (2) the appearance of the displaced TIR laser beam, visualized at the back focal plane of the objective lens using the microscopes' eyepiece, and (3) a sudden decrease in the background intensity, which increases the signal to background for single-molecule imaging. A ≧2-fold increase in signal to background was achieved in images of single fluorophores immobilized on the SiN membrane over epi-illumination (illumination and detection from one side of the sample).

### Synchronous Detection of Optical and Electrical Signals

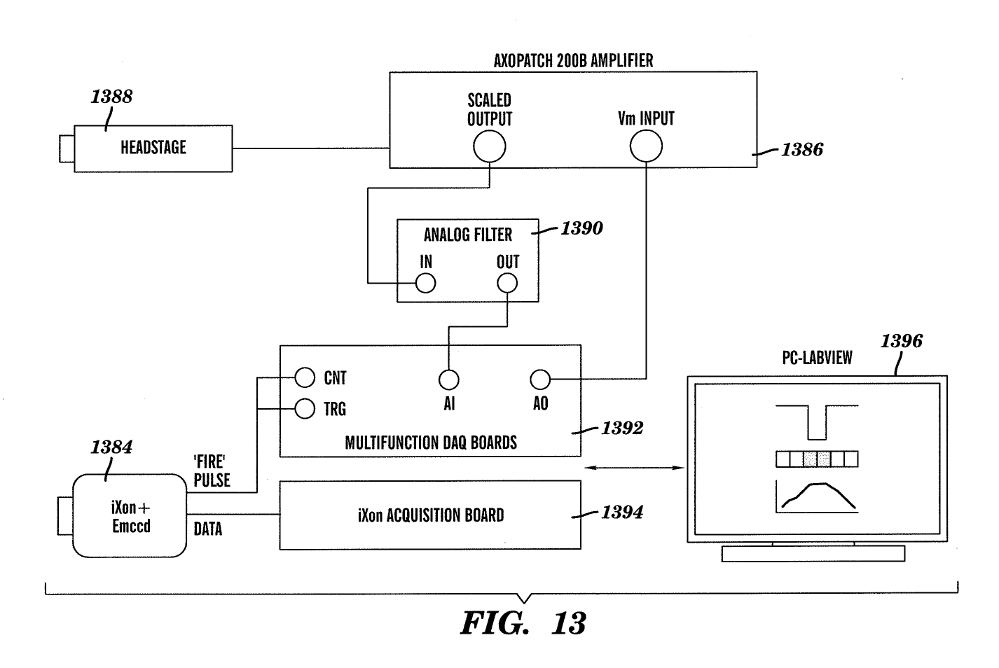

For synchronous detection of the optical and electrical signals, a combination of hardware (e.g., Microsoft Windows or Linux compatible personal computer) and LABVIEW software was designed. FIG. 13 schematically illustrates the acquisition hardware. An Axopath 200B amplifier 1386 (Molecular Devices, Inc., Sunnyvale, Calif., USA) was connected to the Ag/AgCl electrodes via headstage 1388 to amplify the ion current signals across the nanopore. The ion current signals were low pass-filtered at 50 KHz using an external four-pole Butterworth filter 1390 and input to a multifunction data acquisition board 1392 in the same PC that received the image data from CCD camera via the image acquisition board 1394 (Andor iXon Acquisition Board). The multifunction data acquisition DAQ board 1392 (National Instruments, PCI-6154) was used to acquire ion-current signal at 16 bit analog to digital conversion resolution. The “fire” pulse (a TTL pulse marking the beginning of each exposure) from the EM-CCD camera 1384 triggered the ion-current acquisition and was used to produce accurate time stamps on a counter board (National Instruments, PCI-6602). The counter board was internally synchronized to the DAQ board using the RTSI bus with a clock rate of 250 KHz. The combined data stream, therefore, included a unique time stamp at the beginning of each of the CCD frames, which were synchronized with the ion-current sampling. When a translocation event was detected by the drop in the ion current, the software 1396 searched for the corresponding frame number in the counter information and saved the actual images corresponding to this number. The camera frame rate was set to approximately 1 KHz (fire pulse rate).

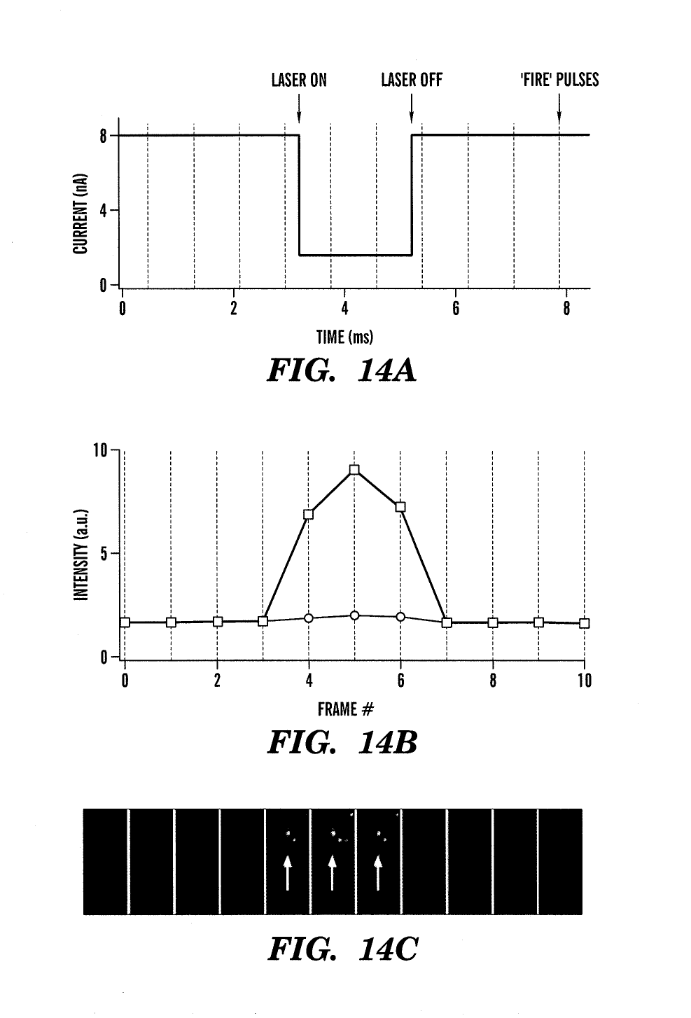

FIGS. 14A-C illustrate synchronization of the electrical and optical signals. Millisecond long electrical pulses generated by a function generator were electrically coupled to the amplifier headstage. These current pulses are similar in shape and timescale of nanopore signals. The excitation laser was modulated ON/OFF using the same signal, providing a synchronous source of light and electrical pulses. For the synchronization tests, fluorescent beads were immobilized on the membrane and imaged using the camera as described above.

The two modalities were combined to measure synchronous optical and electrical signals during DNA translocation through a nanopore. The pore location was first identified on the membrane. The fluorescence signal from the pore is stationary in position and lights up in-sync with the electrical signal; thus, the pixel corresponding to the pore location, over time, accumulates the highest fluorescence intensity, and a summation of the images reveals a peak corresponding to the pore position on the CCD. Once the pore location was identified, intensities from the pixel corresponding to the pore were used for further data analysis.

### Example 3

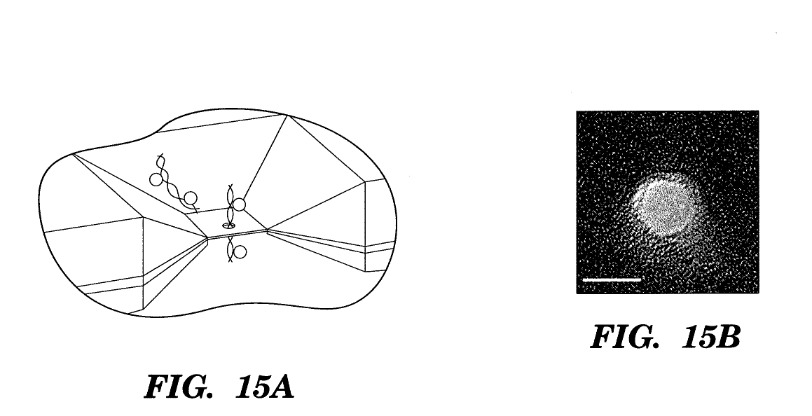

Simultaneous optical and electrical measurements were performed to detect the fluorophore-labeled dsDNA translocating through a 4 nm pore. Sample concentrations in this experiments was 0.1 nM-0.2 nM. FIGS. 15A-15B schematically illustrate the pore geometry, and a TEM image of an exemplary approximately 4 nm pore. A 421 bp fragment (DNA-A1647), labeled with Alexa647 fluorophores, was used by incorporation of low concentrations of amine-modified thymine bases during polymerase chain reaction (PCR) reaction followed by conjugation with the amine-reactive dye.

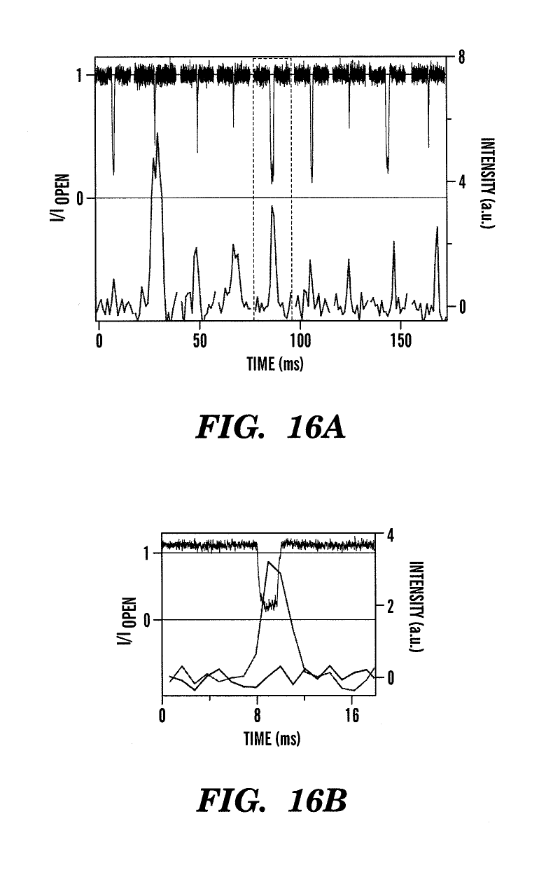

As shown in FIGS. 16A-16B, nine representative ion currents and their corresponding fluorescence intensity events are shown after the DNA-A1647 molecules were added to cis side of the pore (200 mV bias generating an open pore current of 4 nA; images were acquired at 1 ms integration with maximum EM gain). The nanopore location was determined as described above. The fluorescence intensity shown was extracted from a 3×3 pixel area on the CCD centered at the nanopore. It will be appreciated that the synchronous acquisition of current and optical data helps define an internal background threshold for every event. Intensity at the pore location approximately 5 ms before the electrical event was used as the background value for that event. Only optical events in which the intensity at the pore position was at least one standard deviation higher than its corresponding background were included in the analysis to ensure that the event had a meaningful background threshold eliminating spurious signals.

It is understood that the foregoing detailed description and the following examples are illustrative only and are not to be taken as limitations upon the scope of the invention. Various changes and modifications to the disclosed embodiments, which will be apparent to those skilled in the art, may be made without departing from the spirit and scope of the present invention. Further, all patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

1. A fluid cell for an optical microscopy tool comprising:
a solid state membrane having a first side and a second, opposing side;
a first fluid chamber located on the first side of the membrane, the first fluid chamber comprising a first fluid having a first refractive index; and
a second fluid chamber located on the second side of the membrane, the second fluid chamber comprising a second fluid having a second refractive index, the first refractive index being higher than the second refractive index.

2. The fluid cell of claim 1, wherein the solid state membrane comprises silicon nitride.

3. The fluid cell of claim 1, wherein the solid state membrane comprises a single layer dielectric material.

4. The fluid cell of claim 1, wherein the solid state membrane comprises a multi-layer dielectric material.

5. The fluid cell of claim 1, wherein the solid state membrane comprises a silicon nitride layer deposited on a silicon wafer.

6. The fluid cell of claim 5, wherein the silicon nitride layer is 5-60 nm thick.

7. The fluid cell of claim 5, wherein the silicon wafer comprises a window and the silicon nitride layer covers the window.

8. The fluid cell of claim 1, wherein the first fluid comprises an aqueous buffer solution, water or urea.

9. The fluid cell of claim 1, wherein the second fluid is selected from the group consisting of cellular fluid, cell membrane, glycerol and CsCl.

10. The fluid cell of claim 1, wherein the first fluid and the second fluid are aqueous buffers.

11. The fluid cell of claim 1, wherein a biomolecule linked to an optical biomarker is provided on the second side of the membrane.

12. The fluid cell of claim 11, wherein the biomolecule comprises a DNA molecule.

13. The fluid cell of claim 11, wherein the biomolecule comprises a RNA molecule.

14. The fluid cell of claim 11, wherein the biomolecule comprises a protein molecule.

15. The fluid cell of claim 11, wherein the optical biomarker comprises an excitable fluorophore.

16. The fluid cell of claim 1, wherein the first fluid chamber is a microchannel.

17. The fluid cell of claim 1, wherein the solid state membrane comprises at least one nanopore.

18. The fluid cell of claim 1, wherein the solid state membrane comprises a plurality of nanopores.

19. The fluid cell of claim 1, wherein the solid state membrane comprises at least one nanoslit.

20. The fluid cell of claim 17, further comprising first and second electrodes configured to apply an electric potential across the first fluid and the second fluid to drive a biomolecule to be imaged through the nanopore.

21-51. (canceled)

52. A method for imaging a single DNA molecule comprising:
directing light to an objective lens of an optical microscopy tool;
directing the light through a first fluid;
reflecting the light at a silicon nitride membrane to generate a field of evanescent illumination in a second fluid; and
directing light emitted by an optical biomarker excited by the field of evanescent illumination and linked to the single DNA molecule to an imaging detector.

53. The method of claim 52, wherein the first fluid has a refractive index higher than the refractive index of the second fluid.

54. The method of claim 52, wherein the field of evanescent illumination is generated in the second fluid.

55. The method of claim 52, wherein the single DNA molecule is immobilized on the silicon nitride membrane.

56. The method of claim 55, wherein the single DNA molecule is immobilized on the silicon nitride membrane in the second fluid.

57. The method of claim 52, further comprising translocating the single DNA molecule through a nanopore in the silicon nitride membrane.

58-71. (canceled)
